(19) United States
(12) Patent Application Publication
(10) Pub. No.: US 2023/0043269 A1
(43) Pub. Date: Feb. 9, 2023

(54) CHARGING CABINET, BATTERY PACK, AND CHARGING SYSTEM

(71) Applicant: Huawei Digital Power Technologies Co., Ltd., Shenzhen (CN)

(72) Inventors: Yichang WANG, Dongguan (CN); Quanxi LIN, Dongguan (CN); Jianhua ZHU, Dongguan (CN); Ming WAN, Dongguan (CN)

(21) Appl. No.: 17/951,460

(22) Filed: Sep. 23, 2022

Related U.S. Application Data
(63) Continuation of application No. PCT/CN2021/123456, filed on Oct. 13, 2021.

(30) Foreign Application Priority Data
Jun. 28, 2021 (CN) 202121448707.0

(51) Int. Cl. H02J 7/00; H02J 7/04

(52) U.S. Cl. CPC H02J 7/0042; H02J 7/00036; H02J 7/0049; H02J 7/00712; H02J 7/04; H02J 2207/20

(57) ABSTRACT

A charging cabinet includes a power conversion circuit, an input interface, and a plurality of output interfaces. An input end of the power conversion circuit is connected to the input interface. The power conversion circuit converts an alternating current supplied by an alternating current power grid into a direct current, and then charges a plurality of battery packs by using the direct current.

### CROSS-REFERENCE TO RELATED APPLICATIONS

This application is a continuation of International Application No. PCT/CN2021/123456, filed on Oct. 13, 2021, which claims priority to Chinese Patent Application No. 202121448707.0, filed on Jun. 28, 2021. The disclosures of the aforementioned applications are hereby incorporated by reference in their entireties.

### TECHNICAL FIELD

This application relates to the field of charging cabinet technologies, and in particular, to a charging cabinet, a battery pack, and a charging system.

### BACKGROUND

With aggravation of a shortage of energy and environmental pollution in modern society, two-wheeled electric vehicles are more widely applied. Main application scenarios of the two-wheeled electric vehicles include but are not limited to personal use, shared mobility, takeout delivery, and express delivery. As a main component of a two-wheeled electric vehicle, a battery pack is configured to supply electrical energy needed by a motor of the two-wheeled electric vehicle. How to charge a battery pack conveniently, quickly, and safely is one of main issues faced by a two-wheeled electric vehicle.

In recent years, a shared battery exchange manner rapidly develops. The shared battery exchange means that a plurality of battery packs are jointly charged by using a charging cabinet, and after a quantity of electricity of a battery pack is insufficient, a user can go to the charging cabinet to use a battery pack with a sufficient quantity of electricity instead. The charging cabinet charges the battery pack with an insufficient quantity of electricity replaced by the user. Such a manner is convenient, quick, and safe.

A charging rate is a measure of a speed of charging, and refers to a current value needed to charge a battery pack to its rated capacity in a specified time period. A higher charging rate, that is, a larger current for charging the battery pack, leads to a shorter time needed to charge the battery pack to its rated capacity. An existing charging cabinet generally uses an invariable charging rate when charging a battery pack. However, a service requirement of the shared battery exchange fluctuates obviously with a change of regions and time, and adaptability of using an invariable charging rate to fluctuation of the service requirement is poor. In peak periods, users often wait for a long time for a battery pack to be fully charged. This reduces convenience of the shared battery exchange. Increasing a charging rate can reduce a charging time of a battery pack and relieve service pressure, but significantly increases pressure on an alternating current power grid and reduces stability of the alternating current power grid.

### SUMMARY OF UTILITY MODEL

To resolve the foregoing problems, this application provides a charging cabinet, a battery pack, and a charging system, to reduce impact on an alternating current power grid while improving adaptability to fluctuation of a service requirement.

According to a first aspect, this application provides a charging cabinet. The charging cabinet includes a power conversion circuit, an input interface, and a plurality of output interfaces. The input interface is configured to connect to an alternating current power grid, and each of the plurality of output interfaces is configured to connect to one of a plurality of battery packs. The plurality of output interfaces are connected to an output end of the power conversion circuit. An input end of the power conversion circuit is connected to the input interface. The power conversion circuit is configured to: in a first time period, convert an alternating current supplied by the alternating current power grid into a direct current, and then charge the battery packs by using the direct current, so that a state of charge of each of the plurality of battery packs is any one of the following at least two states of charge: a first state of charge or a second state of charge, and a quantity of battery packs in each of the at least two states of charge is kept unchanged in the first time period. There is at least one battery pack in each of the at least two states of charge. The first state of charge is 1, that is, a battery pack in the first state of charge is fully charged. The second state of charge is less than the first state of charge, that is, the battery pack in the first state of charge is not fully charged.

In this solution in this embodiment of this application, the plurality of battery packs charged in the charging cabinet are in the at least two states of charge, and the at least two states of charge include at least the first state of charge and the second state of charge. The first state of charge is 1, a battery in the first state of charge is configured to meet a current service requirement, and a user may directly replace the battery pack in the first state of charge with a battery pack whose quantity of electricity is used up. After the battery pack in the first state of charge is replaced with the battery pack whose quantity of electricity is used up, a battery pack in the second state of charge is charged to be in the first state of charge and is then to be used, and the fully discharged battery pack is charged to be in the second state of charge, so that the quantity of battery packs in each state of charge is kept unchanged. With this solution in this application, the battery pack in the second state of charge is fully charged only after the battery pack in the first state of charge is replaced. Therefore, even if the charging cabinet charges the battery packs at high charging rates in a load peak period of the alternating current power grid, this solution provided in this application reduces a quantity of battery packs that are fully charged in the charging cabinet compared with an existing solution in which all battery packs in a charging cabinet are always fully charged. This reduces charging power of the charging cabinet, and can reduce impact on the alternating current power grid while improving adaptability to fluctuation of a service requirement.

In a possible embodiment, a charging rate at which the power conversion circuit charges a battery pack whose state of charge is less than the second state of charge among the plurality of battery packs to the second state of charge is lower than a charging rate at which the power conversion circuit charges a battery pack whose state of charge is the second state of charge among the plurality of battery packs to the first state of charge.

To be specific, the power conversion circuit charges the fully discharged battery pack to be in the second state of charge at a lower charging rate, to reduce the charging power of the charging cabinet; and the power conversion circuit charges the battery pack from the second state of charge to the first state of charge at a higher charging rate, to quickly meet a requirement of a battery pack replacement service.

In a possible embodiment, the power conversion circuit is further configured to: when the power conversion circuit is not in the first time period, convert the alternating current supplied by the alternating current power grid into a direct current, and then charge the battery packs by using the direct current, so that states of charge of the battery packs are all the first state of charge. The first time period is the load peak period of the power grid. When the power conversion circuit is not in the first time period, that is, when the power conversion circuit is in a valley period of power consumption of the power grid at this time, even if the charging cabinet keeps all the battery packs in a fully charged state, the impact on the alternating current power grid is small. The charging cabinet fully utilizes a quantity of electricity in the load valley period of the alternating current power grid to relieve power consumption pressure in the load peak period of the alternating current power grid, and in the load peak period of the alternating current power grid, the battery packs in the charging cabinet at an initial stage are all in a fully charged state. This can quickly meet the requirement of the battery pack replacement service, and can also reduce the charging power of the charging cabinet at the initial stage of the load peak period of the alternating current power grid and reduce the impact on the alternating current power grid.

In a possible embodiment, the charging cabinet is configured to determine the quantity of battery packs in each state of charge based on an estimated battery pack replacement quantity. In this solution in this application, the estimated battery pack replacement quantity indicates a requirement level of the battery pack replacement service. A larger estimated battery pack replacement quantity indicates a higher requirement of the battery pack replacement service, and a smaller estimated battery pack replacement quantity indicates a lower requirement of the battery pack replacement service. In other words, in this solution in this application, the quantity of battery packs in each state of charge is adjusted based on the requirement of the battery pack replacement service, to better meet the requirement of the battery pack replacement service.

In a possible embodiment, the charging cabinet further includes a network interface, the network interface is configured to connect to a server, and the charging cabinet obtains the estimated battery pack replacement quantity from the server. In this way, the charging cabinet can automatically update the estimated battery pack replacement quantity, to better meet the requirement of the battery pack replacement service. In addition, the charging cabinet may further obtain, from the server, a time period corresponding to the load peak of the alternating current power grid, that is, obtain the first time period.

In a possible embodiment, a quantity of battery packs in the second state of charge among the plurality of battery packs is negatively correlated with the estimated battery pack replacement quantity, and a quantity of battery packs in the first state of charge among the plurality of battery packs is positively correlated with the estimated battery pack replacement quantity.

In other words, a higher requirement of the battery pack replacement service indicates a larger quantity of corresponding battery packs in a first state-of-charge region among the plurality of battery packs, and in this case, there are a larger quantity of spare battery packs in a fully charged state in the charging cabinet. The battery pack in the fully charged state may be directly replaced with another battery pack and then may be used, to better meet the requirement of the battery pack replacement service.

In a possible embodiment, the power conversion circuit is further configured to adjust charging rates at which the plurality of battery packs are charged, to better meet the requirement of the battery pack replacement service, and minimize the impact on the alternating current power grid.

In a possible embodiment, the charging rate at which the power conversion circuit charges the battery pack whose state of charge is less than the second state of charge among the plurality of battery packs to the second state of charge is positively correlated with the estimated battery pack replacement quantity, and the charging rate at which the power conversion circuit charges the battery pack whose state of charge is the second state of charge among the plurality of battery packs to the first state of charge is positively correlated with the estimated battery pack replacement quantity.

In this solution, the estimated battery pack replacement quantity indicates the requirement level of the battery pack replacement service. A larger estimated battery pack replacement quantity indicates a higher requirement of the battery pack replacement service, and in this case, the battery pack is charged at a higher charging rate, to meet the service requirement. A smaller estimated battery pack replacement quantity indicates a lower requirement of the battery pack replacement service, and in this case, the battery pack is charged at a lower charging rate, to reduce the impact on the alternating current power grid.

In a possible embodiment, the power conversion circuit charges the battery pack whose state of charge is less than the second state of charge among the plurality of battery packs to the second state of charge at a gradually decreasing charging rate, and charges the battery pack whose state of charge is the second state of charge among the plurality of battery packs to the first state of charge at a gradually decreasing charging rate. This avoids damaging the battery packs when the battery packs are continuously charged with a large charging current, in addition to meeting the requirement of the battery pack replacement service in a current time period.

In a possible embodiment, the power conversion circuit charges the battery pack whose state of charge is less than the second state of charge among the plurality of battery packs to the second state of charge at a gradually increasing charging rate, and charges the battery pack whose state of charge is the second state of charge among the plurality of battery packs to the first state of charge at a gradually increasing charging rate. This avoids damaging the battery packs when the battery packs are continuously charged with a large charging current, in addition to meeting the requirement of the battery pack replacement service in a current time period.

In a possible embodiment, the at least two states of charge further include a third state of charge, and the third state of charge is greater than the second state of charge and is less than the first state of charge.

In a possible embodiment, the charging cabinet further includes a first controller. The first controller is configured to: obtain detection information sent by a second controller of each of the plurality of battery packs, and control the power conversion circuit based on the detection information, where the detection information indicates a state of charge of a corresponding battery pack.

In a possible embodiment, the first controller is further configured to determine a quantity of to-be-charged battery packs based on the state of charge of each of the plurality of battery packs and the quantity of battery packs in each of the at least two states of charge. The charging rate at which the power conversion circuit charges the battery pack whose state of charge is less than the second state of charge among the plurality of battery packs to the second state of charge is positively correlated with the quantity of to-be-charged battery packs, and the charging rate at which the power conversion circuit charges the battery pack whose state of charge is the second state of charge among the plurality of battery packs to the first state of charge is positively correlated with the quantity of to-be-charged battery packs.

In this case, the charging cabinet may adjust the charging rates based on an actual status of the battery pack replacement service. When a plurality of fully charged battery packs are replaced with fully discharged battery packs, because there are a large quantity of to-be-charged battery packs, the charging cabinet can charge the battery packs at a high charging rate in this case, to quickly restore the quantity of battery packs in each state of charge. When there are a small quantity of to-be-charged battery packs, the charging cabinet can charge the battery packs at a low charging rate, to reduce the impact on the power grid.

In a possible embodiment, the power conversion circuit includes an alternating current/direct current conversion circuit and a plurality of direct current/direct current conversion circuits. An input end of the alternating current/direct current conversion circuit is the input end of the power conversion circuit, an output end of the alternating current/direct current conversion circuit is connected to input ends of the plurality of direct current/direct current conversion circuits, and an output end of each of the plurality of direct current/direct current conversion circuits is configured to connect to one of the plurality of output interfaces. Each of the plurality of direct current/direct current conversion circuits performs direct current conversion on a direct current, and through the output interface correspondingly connected to the direct current/direct current conversion circuit, output a direct current obtained through the direct current conversion. The first controller controls the alternating current/direct current conversion circuit and the plurality of direct current/direct current conversion circuits based on the detection information, to adjust the charging rates at which the battery packs are charged.

The charging cabinet includes the direct current/direct current conversion circuits. Regardless of whether a charged battery pack includes a direct current/direct current conversion circuit, the charging cabinet can output a direct current to charge the battery pack, and therefore has wide adaptability.

In a possible embodiment, the battery pack includes a direct current/direct current conversion circuit and a second controller, and the power conversion circuit is an alternating current/direct current conversion circuit. An output end of the alternating current/direct current conversion circuit is configured to connect to an input end of the direct current/direct current conversion circuit of each battery pack. The first controller is configured to: control the alternating current/direct current conversion circuit based on the detection information, and separately send a corresponding control signal to the second controller of each of the plurality of battery packs, so that the second controller of each of the plurality of battery packs controls a corresponding direct current/direct current conversion circuit based on the control signal.

In this case, a direct current/direct current conversion circuit may not be disposed on the charging cabinet. This reduces hardware costs and power of the charging cabinet, and facilitates maintenance of the charging cabinet. In addition, when the direct current/direct current conversion circuit of the battery pack is faulty, only the battery pack may need to be replaced, and the charging cabinet may not need to be shut down for maintenance. In this way, the charging cabinet can continue charging other normal battery packs.

In a possible embodiment, the first time period is the time period corresponding to the load peak of the power grid. The first time period may be preset, or the charging cabinet obtains the first time period from the server.

According to a second aspect, this application further provides a battery pack. The battery pack is charged by using the charging cabinet provided in the foregoing embodiments, and the battery pack includes a direct current/direct current conversion circuit, a battery cell, and a second controller. An input end of the direct current/direct current conversion circuit is configured to connect to one of the plurality of output interfaces of the charging cabinet. The direct current/direct current conversion circuit is configured to: perform direct current conversion on an obtained direct current, and then charge the battery cell by using a direct current obtained through the direct current conversion. The second controller is configured to send detection information indicating a state of charge of the battery pack to the charging cabinet.

The battery pack includes the direct current/direct current conversion circuit, to adjust a value of a current for charging the battery cell. Therefore, a direct current/direct current conversion circuit may not be disposed on the charging cabinet that charges the battery pack. This reduces hardware costs and power of the charging cabinet, and facilitates maintenance of the charging cabinet.

In a possible embodiment, the second controller is further configured to control the direct current/direct current conversion circuit based on an obtained control signal, to adjust a charging rate at which the battery cell is charged.

According to a third aspect, this application further provides a battery pack charging system, including a battery pack and a charging cabinet. In a possible embodiment, the battery pack includes a direct current/direct current conversion circuit, and in this case, the charging cabinet may include a direct current/direct current conversion circuit or may not include a direct current/direct current conversion circuit. In another possible embodiment, the battery pack does not include a direct current/direct current conversion circuit, and in this case, the charging cabinet includes a direct current/direct current conversion circuit.

A plurality of battery packs in the charging cabinet are in at least two states of charge, and the at least two states of charge include a first state of charge and a second state of charge. The first state of charge is 1, a battery in the first state of charge is configured to meet a current battery exchange service requirement, and a user may directly replace a battery pack in the first state of charge with a battery pack whose quantity of electricity is used up. After the battery pack in the first state of charge is replaced with the battery pack whose quantity of electricity is used up, a battery pack in the second state of charge is charged to be in the first state of charge, and the fully discharged battery pack is charged to be in the second state of charge, so that a quantity of battery packs in each state of charge is kept unchanged. The battery pack in the second state of charge is fully charged only after the battery pack in the first state of charge is replaced. Otherwise, the battery pack in the second state of charge may remain in the second state of charge. Therefore, even if the charging cabinet charges the battery packs at high charging rates in a load peak period of an alternating current power grid, a quantity of battery packs in a fully charged state in the charging cabinet is reduced compared with an existing solution in which all battery packs in a charging cabinet are always fully charged. This reduces charging power of the charging cabinet, and can reduce impact on the alternating current power grid while improving adaptability to fluctuation of a service requirement.

### BRIEF DESCRIPTION OF DRAWINGS

FIG. 1 is a schematic line graph of a relationship between a charging current and time;

FIG. 2 is a schematic diagram of a charging system in which a charging cabinet is located according to an embodiment of this application;

FIG. 3 is a schematic diagram 1 when battery packs are in different states of charge according to an embodiment of this application;

FIG. 4 is a schematic diagram 2 when battery packs are in different states of charge according to an embodiment of this application;

FIG. 5 is a schematic diagram 3 when battery packs are in different states of charge according to an embodiment of this application;

FIG. 6 is a schematic diagram 4 when battery packs are in different states of charge according to an embodiment of this application;

FIG. 7 is a schematic diagram 5 when battery packs are in different states of charge according to an embodiment of this application;

FIG. 8 is a schematic diagram 6 when battery packs are in different states of charge according to an embodiment of this application;

FIG. 9 is a schematic diagram 7 when battery packs are in different states of charge according to an embodiment of this application;

FIG. 10 is a diagram 1 of a relationship between a charging current and time according to an embodiment of this application;

FIG. 11 is a diagram 2 of a relationship between a charging current and time according to an embodiment of this application;

FIG. 12 is a diagram 3 of a relationship between a charging current and time according to an embodiment of this application;

FIG. 13 is a schematic diagram of a charging system in which a charging cabinet is located according to an embodiment of this application;

FIG. 14 is another schematic diagram of a charging system in which a charging cabinet is located according to an embodiment of this application; and

FIG. 15 is a schematic diagram of a battery pack charging system according to an embodiment of this application.

### DESCRIPTION OF EMBODIMENTS

To make a person skilled in the art better understand technical solutions provided in embodiments of this application, the following first describes an application scenario of the technical solutions provided in this application.

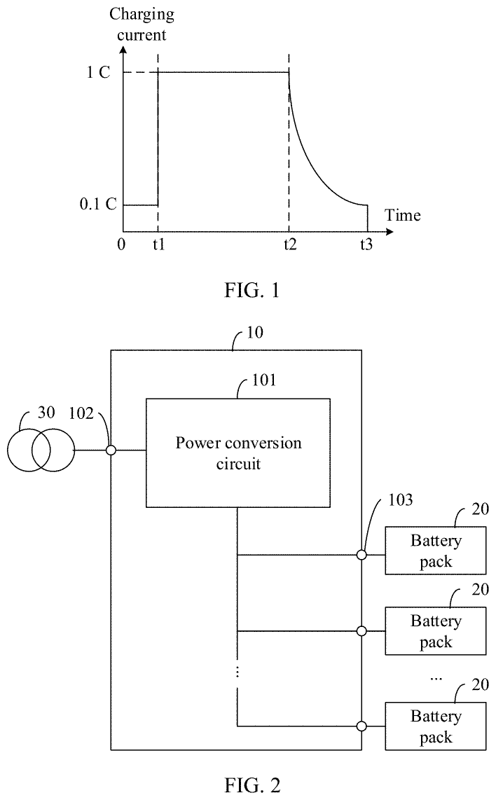

FIG. 1 is a schematic line graph of a relationship between a charging current and time.

A charging process in which a charging cabinet charges a battery pack is mainly divided into three stages: a trickle charging stage in a period 0-t1, a constant-current charging stage in a period t1-t2, and a constant-voltage charging stage in a period t2-t3.

The trickle charging stage is a low-voltage precharge stage, and is used to protect the battery pack. A charging current at the trickle charging stage is small and a charging time is short. A charging current value at the illustrated trickle charging stage in the figure is 0.1 C.

C (Capacity) indicates the charging current value when the battery pack is charged. 1 C indicates a current value needed to charge the battery pack from a fully discharged state to a fully charged state within one hour.

A quantity of electricity of the battery pack may be represented by using a state of charge (SOC). The SOC refers to a ratio of a remaining quantity of electricity of the battery pack to a quantity of electricity when the battery pack is fully charged, and a value range is 0 to 1. When the SOC is 0, it indicates that the battery pack is fully discharged. When the SOC is 1, it indicates that the battery pack is fully charged. Therefore, 1 C may also indicate a current value needed to charge the battery pack from a fully discharged state to a SOC being 1 within one hour.

A specific charging current value indicated by 1 C is related to a capacity of the battery pack. For example, for a battery pack whose capacity is 20 ampere hours (Ah), 0.1 C indicates a charging current value of 2 A, and 1 C indicates a charging current value of 20 A. For a battery pack whose capacity is 10 Ah, 0.1 C indicates a charging current value of 1 A, and 1 C indicates a charging current value of 10 A.

At the constant-current charging stage in the period t1-t2, the battery pack is charged by using an invariable charging current value, namely, an invariable charging rate. That the charging current value is invariably 1 C is used as an example in the figure. Actually, the charging current value may be invariably another value. Duration of the constant-current charging stage is negatively correlated with the charging current value (namely, the charging rate).

At the constant-voltage charging stage in the period t2-t3, the battery pack is charged by using an invariable voltage, and duration of the process is short.

In summary, the duration of the constant-current charging stage occupies a main part of a charging time of the battery pack. In other words, charging duration of the battery pack is mainly determined by a length of the constant-current charging process of the battery pack.

A requirement of a battery pack replacement service fluctuates obviously with a change of regions and time, and adaptability of using an invariable charging rate to fluctuation of the requirement of the battery pack replacement service. In a peak period of the battery pack replacement service, because there is a large battery pack replacement quantity, users often need to wait for a long time for a battery pack to be fully charged. This reduces convenience of the shared battery exchange and affects user experience. To alleviate the foregoing problem, a charging rate at which a battery pack is charged is generally increased, that is, a charging current at the constant-current charging stage is increased. However, such a manner significantly increases power when the battery pack is charged, increases pressure on an alternating current power grid in the load peak period of the alternating current power grid, and reduces stability of the alternating current power grid.

To resolve the foregoing problem, this application provides a charging cabinet, a battery pack, and a charging system. Each of a plurality of battery packs charged in the charging cabinet is in at least two states of charge, and the at least two states of charge include a first state of charge and a second state of charge. The first state of charge is 1, the second state of charge is less than the first state of charge, and there is at least one battery pack in each of the at least two states of charge. A battery pack in the first state of charge is directly replaced with another battery pack, to meet a service requirement. After the battery pack in the first state of charge is replaced with a battery pack whose quantity of electricity is used up, a battery pack in the second state of charge is charged to be in the first state of charge and is then to be used, and the battery pack whose quantity of electricity is used up is charged to be in the second state of charge, so that a quantity of battery packs in each state of charge is kept unchanged. With this solution, even if the charging cabinet charges the battery packs at high charging rates in a load peak period of an alternating current power grid, this solution reduces a quantity of battery packs in a fully charged state in the charging cabinet compared with an existing solution in which all battery packs in a charging cabinet are always fully charged. This reduces charging power of the charging cabinet and reduces impact on the alternating current power grid.

Terms such as “first” and “second” in the following descriptions of this application are merely for description, and shall not be understood as an indication or implication of relative importance or implicit indication of a quantity of indicated technical features.

In this application, unless otherwise clearly specified and limited, a term “connection” should serve as an understanding in a broad sense. For example, “connection” may be a fixed connection, may be a detachable connection, or may mean an integrated structure; may be a direct connection, or may be an indirect connection through an intermediary.

This application provides a charging cabinet, configured to charge a battery pack. The following provides a detailed description with reference to the accompanying drawings. It can be understood that, for an application scenario of the technical solution in this application, a fully charged battery pack in the charging cabinet is always replaced with a fully discharged battery pack. In other words, a total quantity of battery packs connected to the charging cabinet is kept unchanged before and after a battery pack replacement service is performed. In addition, the following uses an example for description in which the quantity of battery packs connected to the charging cabinet is kept unchanged before and after the battery pack replacement service is performed.

FIG. 2 is a schematic diagram of a charging system in which a charging cabinet is located according to an embodiment of this application.

The charging system includes a charging cabinet 10 and a plurality of battery packs 20.

The charging cabinet 10 includes a power conversion circuit 101, an input interface 102, and a plurality of output interfaces 103.

The input interface 102 is configured to connect to an alternating current power grid 30, and each output interface 103 is configured to connect to one battery pack 20. A quantity of output interfaces 103 included in the charging cabinet 10 is not specifically limited in this embodiment of this application.

An input end of the power conversion circuit 101 is connected to the input interface 102, and an output end of the power conversion circuit 101 is connected to each output interface 103. The power conversion circuit 101 is configured to: convert an alternating current supplied by the alternating current power grid 30 into a direct current, and then charge the battery packs 20 by using the direct current.

The following describes a working principle of the charging cabinet 10. For ease of description, the following uses an example for description in which the charging cabinet 10 can accommodate 12 battery packs. In other words, the charging cabinet 10 includes 12 output interfaces, and can simultaneously charge the 12 battery packs. When a quantity of battery packs accommodated in the charging cabinet is not 12, a principle thereof is similar to that of the 12 battery packs. Details are not described in this embodiment of this application again.

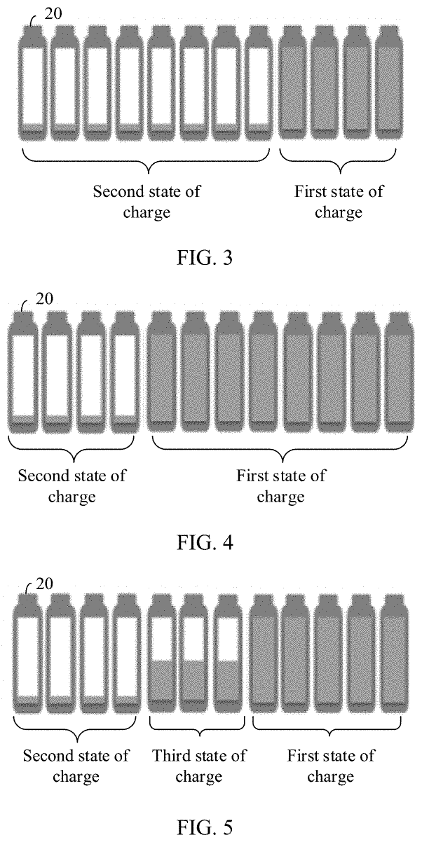

Also refer to FIG. 3 and FIG. 4. FIG. 3 is a schematic diagram 1 when battery packs are in different states of charge according to an embodiment of this application. FIG. 4 is a schematic diagram 2 when battery packs are in different states of charge according to an embodiment of this application.

In a first time period, the power conversion circuit charges the battery packs, so that a state of charge of each battery pack is any one of the following at least two states of charge: a first state of charge or a second state of charge. The first time period in this embodiment of this application is a load peak period of the alternating current power grid. The first time period may be preset, and the first time period may be adjusted and modified depending on an actual situation.

FIG. 3 and FIG. 4 are schematic diagrams when two states of charge are included, and there is at least one battery pack in each state of charge.

A state of charge of a battery pack in the first state of charge is 100%, that is, the battery pack is fully charged, so that the battery pack is directly replaced with another battery pack and then is used. A state of charge of a battery pack in the second state of charge is small. The second state of charge is not specifically limited in this embodiment of this application. For example, the second state of charge is 10%.

A quantity of battery packs in the first state of charge and a quantity of battery packs in the second state of charge are not specifically limited in this embodiment of this application. For example, in FIG. 3, there are four battery packs in the first state of charge, and there are eight battery packs in the second state of charge. For another example, in FIG. 4, there are eight battery packs in the first state of charge, and there are four battery packs in the second state of charge.

In actual application, the quantity of battery packs in the first state of charge and the quantity of battery packs in the second state of charge may be determined based on an estimated battery pack replacement quantity. The estimated battery pack replacement quantity indicates a requirement level of the battery pack replacement service. A larger estimated battery pack replacement quantity indicates a higher requirement of the battery pack replacement service, and a correspondingly larger quantity of battery packs in the first state of charge in this case. Then, an estimated battery pack replacement quantity corresponding to FIG. 4 is greater than an estimated battery pack replacement quantity corresponding to FIG. 3.

After the battery pack in the first state of charge is replaced with a battery pack whose quantity of electricity is used up, the battery pack in the second state of charge is charged to be in the first state of charge, and the charging cabinet charges the battery pack whose quantity of electricity is used up, to make a state of charge of the battery pack in the second state of charge, so that a quantity of battery packs in each state of charge is kept unchanged.

In this application, keeping the quantity of battery packs in each state of charge unchanged is a state that is expected in a process of continuously replacing battery packs in the charging cabinet. In some cases, for example, when a user replaces a battery pack that is not fully charged with a fully charged battery pack, the quantity of battery packs actually in the first state of charge may be greater than a quantity of battery packs expected to be kept in a first state-of-charge region. In this case, the battery cabinet does not discharge a battery pack for the purpose of maintaining the quantity of battery packs in the first state of charge. For another example, when a user replaces the battery pack in the second state of charge in the battery cabinet with a battery pack whose state of charge is greater than the second state of charge, the state of charge of the battery pack is greater than the second state of charge and is less than the first state of charge in this case.

In this solution provided in this embodiment of this application, the battery pack in the second state of charge is charged to be in the first state of charge only after the battery pack in the first state of charge is replaced. Otherwise, the battery pack in the second state of charge may remain in the second state of charge. The second state of charge is less than the first state of charge. Therefore, even if the charging cabinet charges the battery packs at high charging rates in the load peak period of the alternating current power grid, a quantity of battery packs kept in a fully charged state in the charging cabinet is reduced compared with an existing solution in which all battery packs in a charging cabinet are always fully charged. This can reduce charging power of the charging cabinet and can reduce impact on the alternating current power grid, while meeting the requirement of the battery pack replacement service.

Charging rates at which the charging cabinet charges battery packs to be in different states of charge may be identical or different. The following describes an embodiment when the charging rates are different.

In some embodiments, after the battery pack in the first state of charge is replaced with another battery pack and is then used, when the power conversion circuit of the charging cabinet charges a fully discharged battery pack, a charging rate at which the fully discharged battery pack is charged to be in the second state of charge is a first charging rate, and a charging rate at which the state of charge of the battery pack is charged from the second state of charge to the first state of charge is a second charging rate. The second charging rate is higher than the first charging rate.

To be specific, the fully discharged battery pack is charged to be in the second state of charge at a lower charging rate, to reduce the charging power of the charging cabinet; and the battery pack is charged from the second state of charge to the first state of charge at a higher charging rate, to quickly meet the requirement of the battery pack replacement service. It can be learned that the foregoing charging manner with a variable charging rate further reduces the impact on the alternating current power grid.

To fully utilize a quantity of electricity in a load valley period of the alternating current power grid to relieve power consumption pressure in the load peak period of the alternating current power grid, when the power conversion circuit of the charging cabinet is not in the first time period, that is, when the power conversion circuit of the charging cabinet is not in the load peak period of the alternating current power grid but in the load valley period of the alternating current power grid, the power conversion circuit of the charging cabinet converts the alternating current supplied by the alternating current power grid into the direct current, and then charges the battery packs by using the direct current, so that the battery packs are all in the first state of charge. In other words, the battery packs are all fully charged. The quantity of electricity in the load valley period of the alternating current power grid is fully utilized for the reason that the pressure on the alternating current power grid is small in this time period, and even if the charging cabinet keeps all the battery packs in a fully charged state, the impact on the alternating current power grid is small. In the load peak period of the alternating current power grid, the battery packs in the charging cabinet at an initial stage are all in a fully charged state. This can quickly meet the requirement of the battery pack replacement service, and can also reduce the charging power of the charging cabinet at the initial stage of the load peak period of the alternating current power grid and reduce the impact on the alternating current power grid.

In the foregoing descriptions, an example is used for description in which a state of charge of a battery pack is either the first state of charge or the second state of charge. In actual application, a state of charge of a battery pack may be alternatively in another state-of-charge region. The following provides a detailed description.

FIG. 5 is a schematic diagram 3 when battery packs are in different states of charge according to an embodiment of this application.

The illustrated different states of charge include a first state of charge, a second state of charge, and a third state of charge. The third state of charge is greater than the second state of charge and is less than the first state of charge. Because the third state of charge is greater than the second state of charge, a time in which the charging cabinet charges a state of charge of a battery pack from the third state of charge to the first state of charge is less than a time in which the charging cabinet charges a state of charge of a battery pack from the second state of charge to the first state of charge at a same charging rate. In this way, compared with FIG. 4, the solution shown in FIG. 5 shortens a time to fully charge a battery pack in case of a high requirement of the battery pack replacement service.

After a battery pack in the first state of charge is replaced with a fully discharged battery pack, the battery pack in the third state of charge may be charged to be in the first state of charge at a high charging rate for a standby purpose, the battery pack in the second state of charge is charged to be in the third state of charge, and the charging cabinet charges the fully discharged battery pack to be in a second state-of-charge region, so that a quantity of battery packs in each state of charge is kept unchanged.

In some embodiments, a charging rate at which the battery pack is charged from the third state of charge to the first state of charge is a first charging rate, a charging rate at which the battery pack is charged from the second state of charge to a state-of-charge region is a second charging rate, and a charging rate at which the battery pack is charged from a fully discharged state to the second state of charge is a third charging rate. In this case, the first charging rate is higher than the second charging rate, and the second charging rate is higher than the third charging rate. This can further reduce the charging power of the charging cabinet and further reduce the impact on the alternating current power grid, while quickly meeting the requirement of the battery pack replacement service.

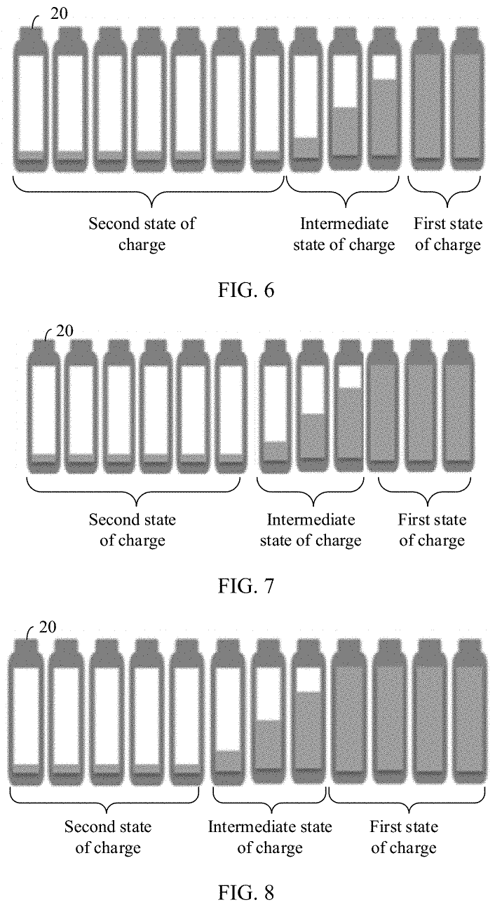

FIG. 6 is a schematic diagram 4 when battery packs are in different states of charge according to an embodiment of this application.

The illustrated different states of charge further include a plurality of intermediate states of charge. The plurality of intermediate states of charge are greater than the second state of charge and are less than the first state of charge, and the plurality of intermediate states of charge present a stepped distribution from low to high.

Also refer to FIG. 6 and FIG. 5. When a quantity of battery packs in the plurality of intermediate states of charge in FIG. 6 is equal to a quantity of battery packs in the third state of charge in FIG. 5, an average state of charge of the battery packs in the plurality of intermediate states of charge shown in FIG. 6 approximates to an average state of charge of the battery packs in the third state of charge shown in FIG. 5. Therefore, when the foregoing two embodiments are used, power of the battery cabinet approximates to each other. In other words, technical effects of reducing the impact on the alternating current power grid are similar to each other.

In actual application, the first time period may include a time period in which a requirement of the battery pack replacement service is high, a time period in which a requirement of the battery pack replacement service is moderate, and a time period in which a requirement of the battery pack replacement service is low. In different service requirement time periods, a quantity of battery packs in each state of charge is adjustable. In this solution provided in this embodiment of this application, to better meet the requirement of the battery pack replacement service, the quantity of battery packs in each state of charge varies with the requirement of the battery pack replacement service. The following provides a detailed description.

In this solution provided in this embodiment of this application, the estimated battery pack replacement quantity indicates the requirement level of the battery pack replacement service. A larger estimated battery pack replacement quantity indicates a higher requirement of the battery pack replacement service, and a smaller estimated battery pack replacement quantity indicates a lower requirement of the battery pack replacement service.

In some embodiments, the charging cabinet may collect statistics on actual battery pack replacement quantities in each time period in a historical period, obtain, by calculating an average value, a battery pack replacement quantity corresponding to each time period, and use an average value of the actual battery pack replacement quantities as an estimated battery pack replacement quantity. In this way, estimated battery pack replacement quantities corresponding to different service requirement time periods are obtained.

For example, the charging cabinet records an actual battery pack replacement quantity in a peak period of a battery pack replacement service requirement of each day in the past thirty days, and uses an average value of 30 actual battery pack replacement quantities as an estimated battery pack replacement quantity corresponding to the peak period of the battery pack replacement service requirement. The charging cabinet may further update the estimated battery pack replacement quantity on a daily basis.

In another embodiment, the charging cabinet further includes a network interface, and the network interface is configured to connect to a server, so that the charging cabinet can automatically obtain, from the server, an estimated battery pack replacement quantity corresponding to each time period, and update the estimated battery pack replacement quantity. The charging cabinet may further obtain, from the server, a time period corresponding to the load peak of the alternating current power grid, that is, obtain the first time period.

After determining the estimated battery pack replacement quantity, the charging cabinet further determines quantities of battery packs corresponding to different states of charge. A correspondence between the quantities of battery packs corresponding to different states of charge and the estimated battery pack replacement quantity is calibrated in advance and is then stored, for example, may be stored in a form of a data table or a function relationship. This is not specifically limited in this embodiment of this application.

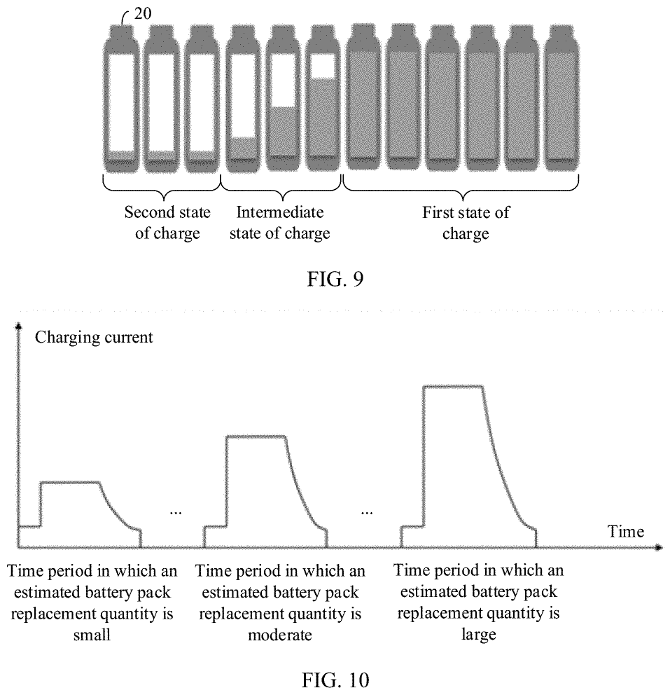

Also refer to schematic diagrams shown in FIG. 7 to FIG. 9 when battery packs are in different states of charge. FIG. 7 shows a distribution of quantities of battery packs in various states of charge in a valley period of a battery pack replacement service requirement. FIG. 8 shows a distribution of quantities of battery packs in various states of charge in a normal period of a battery pack replacement service requirement. FIG. 9 shows a distribution of quantities of battery packs in various states of charge in a peak period of a battery pack replacement service requirement.

The quantities of battery packs in different states of charge are correlated with the estimated battery pack replacement quantity. Specifically, the quantity of battery packs in the second state of charge is negatively correlated with the estimated battery pack replacement quantity, and the quantity of battery packs in the first state of charge is positively correlated with the estimated battery pack replacement quantity. In other words, a higher requirement of the battery pack replacement service indicates a larger quantity of corresponding battery packs in a first state-of-charge region, and in this case, there are a larger quantity of spare battery packs in a fully charged state in the charging cabinet.

The quantity of battery packs in the intermediate states of charge may be kept unchanged, or is negatively correlated with the estimated battery pack replacement quantity. This is not specifically limited in this embodiment of this application.

In summary, with this solution provided in this embodiment of this application, a quantity of battery packs kept in a fully charged state in the charging cabinet is reduced compared with an existing solution in which all battery packs in a charging cabinet are always fully charged. This reduces the charging power of the charging cabinet, and can reduce the impact of the charging cabinet on the alternating current power grid while improving adaptability to fluctuation of a service requirement.

The charging cabinet can adjust the quantity of battery packs in each state of charge based on the requirement level of the battery pack replacement service, and can also adjust, based on the requirement level of the battery pack replacement service, charging rates at which the charging cabinet charges battery packs. The following uses state-of-charge regions corresponding to FIG. 3 and FIG. 4 as an example for description.

FIG. 10 is a diagram 1 of a relationship between a charging current and time according to an embodiment of this application.

Charging rates at which the power conversion circuit of the charging cabinet charges battery packs are positively correlated with the estimated battery pack replacement quantity. In other words, the charging rates are positively correlated with the requirement level of the battery pack replacement service.

When there is a large estimated battery pack replacement quantity, to meet the requirement of the battery pack replacement service, the charging cabinet charges a battery pack at a high charging rate, thereby ensuring that the requirement of the battery pack replacement service is met. The following provides a detailed description by using an example.

In a time period in which the estimated battery pack replacement quantity is small, a charging rate at which the charging cabinet charges a battery pack to be in the second state of charge is a first charging rate, and a charging rate at which the charging cabinet charges a battery pack from the second state of charge to the first state of charge is a second charging rate. In a time period in which the estimated battery pack replacement quantity is large, a charging rate at which the charging cabinet charges a battery pack to be in the second state of charge is a third charging rate, and a charging rate at which the charging cabinet charges a battery pack from the second state of charge to the first state of charge is a fourth charging rate. In this case, the third charging rate is higher than the first charging rate, and the fourth charging rate is higher than the third charging rate. The foregoing describes an embodiment in which the charging cabinet adjusts the charging rate based on the estimated battery pack replacement quantity. The following describes an embodiment in which the charging cabinet adjusts a charging rate in a same service requirement time period.

In a possible embodiment, in a same service requirement time period, charging rates at which the power conversion circuit of the charging cabinet charges battery packs are positively correlated with a current quantity of to-be-charged battery packs. The following provides a detailed description by using an example.

A current time period in which the estimated battery pack replacement quantity is large is used as an example for description. When two battery packs in a fully charged state are replaced with other battery packs and then are used, a charging rate at which the charging cabinet charges two fully discharged battery packs to be in the second state of charge is a first charging rate, a charging rate at which the charging cabinet charges two battery packs in the second state of charge to be in the first state of charge is a second charging rate, and there are four to-be-charged battery packs currently. When three battery packs in a fully charged state are replaced with other battery packs and then are used, a charging rate at which the charging cabinet charges three fully discharged battery packs to be in the second state of charge is a third charging rate, a charging rate at which the charging cabinet charges three battery packs in the second state of charge to be in the first state of charge is a fourth charging rate, and there are six to-be-charged battery packs currently. In this case, the third charging rate is higher than the first charging rate, and the fourth charging rate is higher than the third charging rate, to restore the quantity of battery packs in each state of charge more quickly.

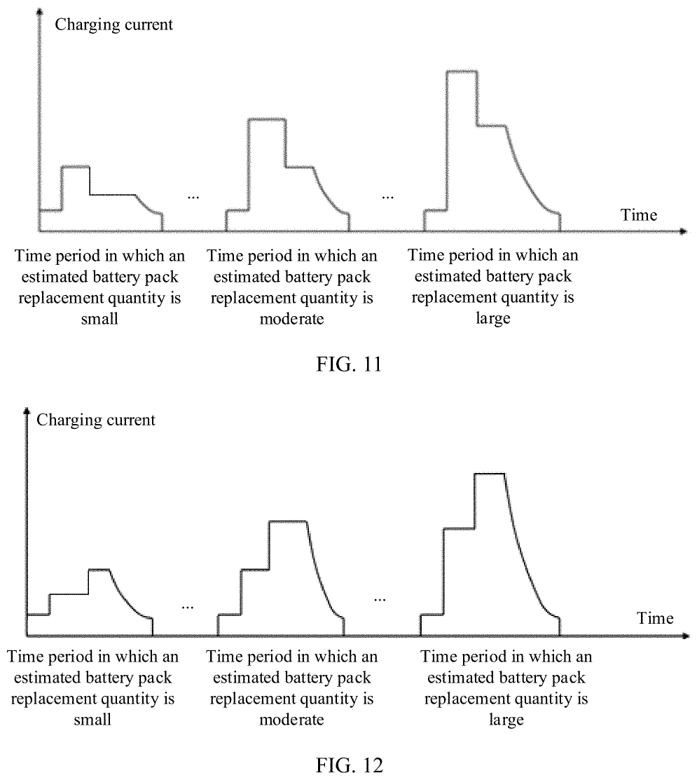

In the time period in which the estimated battery pack replacement quantity is large, charging rates at which the charging cabinet charges battery packs are adjustable. Then, there may be a scenario in which charging rates in FIG. 11 or FIG. 12 change in a stepped manner. The charging rates are positively correlated with the quantity of to-be-charged battery packs. A correspondence between the charging rates and the quantity of to-be-charged battery packs is calibrated in advance and is then stored, for example, may be stored in a form of a data table or a function relationship. This is not specifically limited in this embodiment of this application.

The charging cabinet may determine the quantity of to-be-charged battery packs based on the state of charge of each battery pack and the quantity of battery packs in each state of charge.

In another possible embodiment, refer to a diagram of a relationship between a charging current and time shown in FIG. 11. In a same service requirement time period, charging rates at which the power conversion circuit of the charging cabinet charges battery packs are adjustable. Specifically, to meet the requirement of the battery pack replacement service in the current time period and avoid damaging the battery packs when the battery packs are continuously charged with a large charging current, the charging rate at which the charging cabinet charges the batteries gradually decreases. For example, in the figure, the battery packs are first charged at a higher charging rate, and then the battery packs are charged at a gradually decreasing charging rate in a gradient manner.

In still another possible embodiment, refer to a diagram of a relationship between a charging current and time shown in FIG. 12. In a same service requirement time period, charging rates at which the power conversion circuit of the charging cabinet charges battery packs are adjustable. Specifically, to meet the requirement of the battery pack replacement service in the current time period and avoid damaging the battery packs when the battery packs are continuously charged with a large charging current, the charging rate at which the charging cabinet charges the batteries gradually increases. For example, the power conversion circuit of the charging cabinet first charges the battery packs at a lower charging rate, and then charges the battery packs at a gradually increasing charging rate in a gradient manner.

The foregoing describes a manner of adjusting the charging rates by the charging cabinet. The following describes embodiments of the charging cabinet and battery packs.

Battery packs may be classified into a smart battery pack and a non-smart battery pack. The smart battery pack includes a direct current/direct current conversion circuit, and has a capability of adjusting a current for charging a battery cell of the smart battery pack. The non-smart battery pack includes a direct current/direct current conversion circuit, and can charge a battery cell of the non-smart battery pack only by passively using an external input current. The following first describes an embodiment in which the charging cabinet charges a non-smart battery pack.

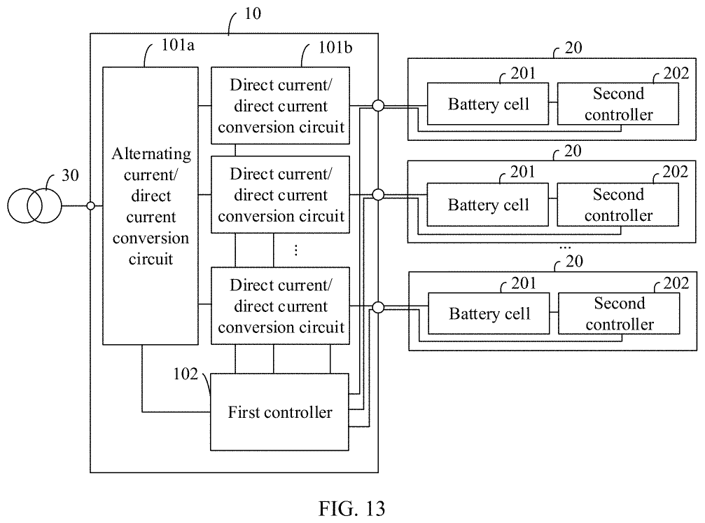

FIG. 13 is a schematic diagram of a charging system in which a charging cabinet is located according to an embodiment of this application.

In this case, a power conversion circuit of the charging cabinet 10 includes an alternating current (AC)/direct current (DC) conversion circuit 101a and a plurality of direct current/direct current conversion circuits 101b. The charging cabinet 10 further includes a first controller 102.

An input end of the alternating current/direct current conversion circuit 101a is an input end of the power conversion circuit, and an output end of the alternating current/direct current conversion circuit 101a is connected to input ends of the plurality of direct current/direct current conversion circuits 101a.

An output end of each direct current/direct current conversion circuit 101b is configured to connect to one output interface.

The direct current/direct current conversion circuits 101b is configured to: perform direct current conversion on an obtained direct current, and through a corresponding output interface, output a direct current obtained through the direct current conversion.

Battery packs 20 connected to output interfaces of the charging cabinet are non-smart battery packs, each of which includes a battery cell 201 and a second controller 202.

The battery cell 201 is configured to store a quantity of electricity. The second controller 202 is configured to communicate with the first controller 201. The second controller 202 can detect a state of charge of the battery cell 201, and send detection information indicating a detection result of detecting the state of charge to the first controller 201.

Power transmission and signal transmission can be performed between the charging cabinet and each battery pack through a corresponding output interface. The power transmission means that the charging cabinet charges the battery pack. The signal transmission means that the first controller 102 of the charging cabinet can obtain, in real time, detection information that indicates the state of charge of the battery pack and that is sent by the second controller 202 of the battery pack.

The first controller 102 determines a current state of charge of a corresponding battery pack based on the obtained detection information indicating the state of charge of the battery pack.

The first controller 102 and the second controllers 202 in this embodiment of this application each may be an application-specific integrated circuit (ASIC), a programmable logic device (PLD), a digital signal processor (DSP), or a combination thereof. The PLD may be a complex programmable logic device (CPLD), a field-programmable gate array (FPGA), a generic array logic (GAL), or any combination thereof. This is not specifically limited in this embodiment of this application.

The alternating current/direct current conversion circuit 101a and the direct current/direct current conversion circuits 101b include power switching devices. The power switching device may be an insulated gate bipolar transistor (IGBT), a metal-oxide-semiconductor field-effect transistor (MOSFET), a silicon carbide metal-oxide-semiconductor field-effect transistor (SiC MOSFET), or the like. This is not specifically limited in this embodiment of this application.

The first controller 102 controls the power switching devices in the alternating current/direct current conversion circuit and the plurality of direct current/direct current conversion circuits, to adjust charging rates at which the battery packs are charged. The first controller 102 is further configured to determine a quantity of to-be-charged battery packs based on the state of charge of each battery pack and a quantity of battery packs in each state of charge.

The following describes an embodiment in which the charging cabinet charges a smart battery pack.

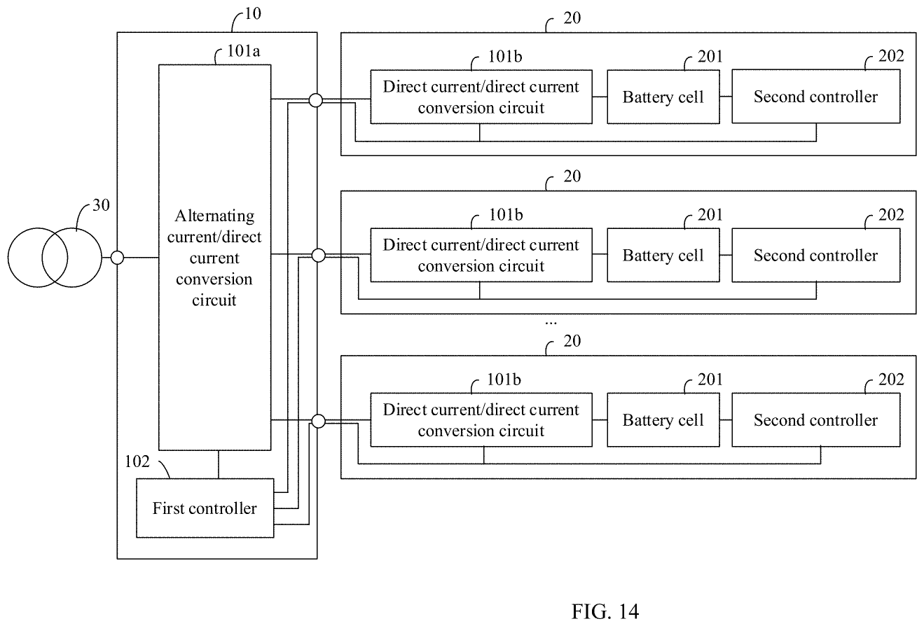

FIG. 14 is another schematic diagram of a charging system in which a charging cabinet is located according to an embodiment of this application.

In this case, a power conversion circuit of the charging cabinet 10 includes an alternating current/direct current conversion circuit 101a. The charging cabinet 10 further includes a first controller 102.

An input end of the alternating current/direct current conversion circuit 101a is an input end of the power conversion circuit, and an output end of the alternating current/direct current conversion circuit 101a is connected to each output interface of the charging cabinet 10.

Battery packs 20 connected to output interfaces of the charging cabinet are smart battery packs. In this case, the battery pack 20 includes a direct current/direct current conversion circuit 101a, a battery cell 201, and a second controller 202.

The battery cell 201 is configured to store a quantity of electricity. An input end of a direct current/direct current conversion circuit 101a is configured to connect to an output interface of the charging cabinet, an output end of the direct current/direct current conversion circuit 101b is connected to a battery cell, and the direct current/direct current conversion circuit 101b is configured to: perform direct current conversion on an obtained direct current, and then charge the battery cell 201 by using a direct current obtained through the direct current conversion.

The second controller 202 is configured to: communicate with the first controller 201, detect a state of charge of the battery cell 201, and send detection information indicating a detection result of detecting the state of charge to the first controller 201. In addition, the second controller 202 is further configured to control a working state of a corresponding direct current/direct current conversion circuit 101b.

Power transmission and signal transmission can be performed between the charging cabinet 10 and each battery pack through a corresponding output interface. The power transmission means that the charging cabinet transmits a direct current to each battery pack. The signal transmission means that the first controller 102 of the charging cabinet can obtain, in real time, detection information sent by the second controller 202 of each battery pack, and send a corresponding control signal to the second controller 202 of the battery pack.

The first controller 102 is further configured to: determine, based on obtained detection information, a current state of charge of a battery pack corresponding to the detection information, generate a control signal, and send the control signal to a corresponding second controller 202, so that the second controller 202 controls a corresponding direct current/direct current conversion circuit 101b based on the control signal.

The first controller 102 is further configured to determine a quantity of to-be-charged battery packs based on the state of charge of each battery pack and a quantity of battery packs in each state of charge.

When the charging cabinet uses the embodiment shown in FIG. 14, compared with the embodiment shown in FIG. 13, disposing a direct current/direct current conversion circuit on the charging cabinet side is avoided. This reduces hardware costs and power of the charging cabinet, and facilitates maintenance of the charging cabinet. In addition, when the direct current/direct current conversion circuit of the battery pack is faulty, only the battery pack may need to be replaced, and the charging cabinet may not need to be shut down for maintenance. In this way, the charging cabinet can continue charging other normal battery packs.

In a possible embodiment, the charging cabinet shown in FIG. 13 may also charge the battery pack 20 (namely, the smart battery pack) shown in FIG. 14, that is, the charging cabinet shown in FIG. 13 has wide adaptability. This is because the charging cabinet shown in FIG. 13 includes the direct current/direct current conversion circuits. Regardless of whether a charged battery pack includes a direct current/direct current conversion circuit, the charging cabinet can output a direct current needed to charge the battery pack.

In summary, in the technical solution provided in this application, an estimated battery pack replacement quantity indicates a requirement level of a battery pack replacement service, and further the charging rates of the battery packs and the quantity of battery packs in each state of charge are adjusted based on fluctuation of the requirement of the battery pack replacement service. The estimated battery pack replacement quantity may be determined based on historical experience or big data analysis. This solution responds to a peak cut power-grid policy. On a premise of meeting the requirement of the battery pack replacement service, battery charge processes are transferred from a load peak period of an alternating current power grid to a load valley period of the alternating current power grid as much as possible, to minimize impact on the alternating current power grid. In addition, the charging rates at which the charging cabinet charges the battery packs are adjustable, so that a change of the requirement of the battery pack replacement service can be better adapted, and that no battery pack is available in peak periods is prevented.

An embodiment of this application further provides a smart battery package. The following provides a detailed description.

Still refer to FIG. 14. Battery packs provided in this embodiment of this application are smart battery packs, and each can adjust a value of a charging current by itself. The battery pack 20 includes a direct current/direct current conversion circuit 101a, a battery cell 201, and a second controller 202.

The battery cell 201 is configured to store a quantity of electricity.

An input end of a direct current/direct current conversion circuit 101a is connected to an output interface of the charging cabinet, an output end of the direct current/direct current conversion circuit 101b is connected to a battery cell, and the direct current/direct current conversion circuit 101b is configured to: perform direct current conversion on an obtained direct current, and then charge the battery cell 201 by using a direct current obtained through the direct current conversion.

The second controller 202 is configured to: control a working state of a corresponding direct current/direct current conversion circuit 101b, detect a state of charge of the battery cell 201 in real time, and send detection information indicating a detection result of the state of charge to the first controller 102.

In addition, the second controller 202 is further configured to: receive a control signal sent by the first controller 102, and control the corresponding direct current/direct current conversion circuit 101b based on the control signal.

The battery pack includes the direct current/direct current conversion circuit, to adjust a value of a current for charging the battery cell. Therefore, a direct current/direct current conversion circuit may not be disposed on the charging cabinet that charges the battery pack. This reduces hardware costs and power of the charging cabinet, and facilitates maintenance of the charging cabinet.

Based on the charging cabinet and the battery packs provided in the foregoing embodiments, an embodiment of this application further provides a battery pack charging system. The following provides a detailed description with reference to the accompanying drawings.

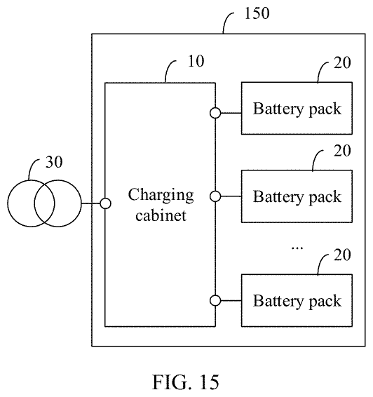

FIG. 15 is a schematic diagram of a battery pack charging system according to an embodiment of this application.

The illustrated battery pack charging system 105 includes a charging cabinet 10 and a plurality of battery packs 20.

In a possible embodiment, the charging cabinet 10 is shown in FIG. 13, and in this case, the battery pack 20 may be a smart battery pack or a non-smart battery pack. In another possible embodiment, the charging cabinet 10 is shown in FIG. 14, and in this case, the battery pack 20 is a smart battery pack, and can adjust a value of a charging current by itself.

For specific embodiments and working principles of the charging cabinet 10 and the battery packs 20, refer to the foregoing descriptions. Details are not described in this embodiment of this application again.

In summary, when the charging cabinet is used to charge the battery packs, the plurality of battery packs charged in the charging cabinet are in at least two states of charge, and the at least two states of charge include a first state of charge and a second state of charge. The first state of charge is 1, a battery in the first state of charge is configured to meet a current battery exchange service requirement, and a user may directly replace a battery pack in the first state of charge with a battery pack whose quantity of electricity is used up. After the battery pack in the first state of charge is replaced with the battery pack whose quantity of electricity is used up, a battery pack in the second state of charge is charged to be in the first state of charge, and a fully discharged battery pack is charged to be in the second state of charge, so that a quantity of battery packs in each state of charge is kept unchanged. The battery pack in the second state of charge is fully charged only after the battery pack in the first state of charge is replaced. Otherwise, the battery pack in the second state of charge may remain in the second state of charge. Therefore, even if the charging cabinet charges the battery packs at high charging rates in a load peak period of an alternating current power grid, a quantity of battery packs in a fully charged state in the charging cabinet is reduced compared with an existing solution in which all battery packs in a charging cabinet are always fully charged. This reduces charging power of the charging cabinet, and can reduce impact on the alternating current power grid while improving adaptability to fluctuation of a service requirement.

Further, the charging cabinet can charge the battery packs at adjustable charging currents (namely, adjustable charging rates). The charging cabinet adjusts, based on a requirement level of a battery pack replacement service, the charging rates at which the charging cabinet charges the battery packs. Specifically, the charging rates at which the charging cabinet charges the battery packs are positively correlated with an estimated battery pack replacement quantity. In addition, in a same service requirement time period, the charging cabinet can also adjust the charging rates. Specifically, in some embodiments, the charging rates at which the power conversion circuit of the charging cabinet charges the battery packs are positively correlated with a current quantity of to-be-charged battery packs. In some other embodiments, to avoid damaging the battery packs when the battery packs are continuously charged with a large charging current, the charging cabinet may charge the battery packs at a gradually decreasing or gradually increasing charging rate.

It should be understood that, in this application, “at least one piece (item)” means one or more, and “a plurality of” means two or more. The term “and/or” is used to describe an association relationship between associated objects, and indicates that three relationships may exist. For example, “A and/or B” may indicate the following three cases: Only A exists, only B exists, and both A and B exist. A and B each may be singular or plural. The character “/” generally indicates an “or” relationship between associated objects. “At least one of the following items (pieces)” or a similar expression thereof indicates any combination of these items, including a single item (piece) or any combination of a plurality of items (pieces). For example, at least one item (piece) of a, b, or c may represent: a, b, c, “a and b”, “a and c”, “b and c”, or “a, b, and c”, where a, b, and c each may be singular or plural.

Embodiments in this specification are all described in a progressive manner. For same or similar parts in embodiments, refer to these embodiments. Each embodiment focuses on a difference from other embodiments. The apparatus embodiments described above are merely examples, and the units and modules described as separation parts may or may not be physically separate. In addition, some or all of the units and modules may be selected depending on an actual requirement to achieve the objectives of the solutions in embodiments. A person of ordinary skill in the art may understand and implement the solutions in embodiments without creative efforts.

The foregoing descriptions are merely specific embodiments of this application. It should be noted that a person of ordinary skill in the art can further make several improvements and modifications without departing from the principles of this application, and these improvements and modifications shall also be considered as the protection scope of this application.

What is claimed is:

1. A charging cabinet comprising a power conversion circuit, an input interface, and a plurality of output interfaces,
wherein the charging cabinet is configured to connect to a plurality of battery packs,
wherein the input interface is configured to connect to an alternating current power grid, and each of the plurality of output interfaces is configured to connect to one of the plurality of battery packs,
wherein the plurality of output interfaces are configured to connect to an output end of the power conversion circuit,
wherein an input end of the power conversion circuit is configured to connect to the input interface, and
wherein the power conversion circuit is configured to, in a first time period, convert an alternating current supplied by the alternating current power grid into a direct current, and then charge the plurality of battery packs by using the direct current, so that a state of charge of each of the plurality of battery packs is any one of the following at least two states of charge: a first state of charge or a second state of charge, and a quantity of battery packs in each of the at least two states of charge is kept unchanged in the first time period, wherein the first state of charge is 1, the second state of charge is less than the first state of charge, and there is at least one battery pack in each of the at least two states of charge.

2. The charging cabinet according to claim 1, wherein a charging rate at which the power conversion circuit charges a battery pack whose state of charge is less than the second state of charge among the plurality of battery packs to the second state of charge is lower than a charging rate at which the power conversion circuit charges a battery pack whose state of charge is the second state of charge among the plurality of battery packs to the first state of charge.

3. The charging cabinet according to claim 1, wherein the power conversion circuit is further configured to: when the power conversion circuit is not in the first time period, convert the alternating current supplied by the alternating current power grid into a direct current, and then charge the plurality of battery packs by using the direct current, so that states of charge of the plurality of battery packs are all the first state of charge.

4. The charging cabinet according to claim 2, wherein the power conversion circuit is further configured to: when the power conversion circuit is not in the first time period, convert the alternating current supplied by the alternating current power grid into a direct current, and then charge the plurality of battery packs by using the direct current, so that states of charge of the plurality of battery packs are all the first state of charge.

5. The charging cabinet according to claim 1, wherein the charging cabinet is further configured to determine the quantity of battery packs in each of the at least two states of charge based on an estimated battery pack replacement quantity.

6. The charging cabinet according to claim 5, wherein the charging cabinet further comprises a network interface, the network interface is configured to connect to a server, and the charging cabinet obtains the estimated battery pack replacement quantity from the server.

7. The charging cabinet according to claim 5, wherein a quantity of battery packs in the second state of charge among the plurality of battery packs is negatively correlated with the estimated battery pack replacement quantity, and a quantity of battery packs in the first state of charge among the plurality of battery packs is positively correlated with the estimated battery pack replacement quantity.

8. The charging cabinet according to claim 7, wherein the power conversion circuit is further configured to adjust charging rates at which the plurality of battery packs are charged.

9. The charging cabinet according to claim 8, wherein the charging rate at which the power conversion circuit charges the battery pack whose state of charge is less than the second state of charge among the plurality of battery packs to the second state of charge is positively correlated with the estimated battery pack replacement quantity, and the charging rate at which the power conversion circuit charges the battery pack whose state of charge is the second state of charge among the plurality of battery packs to the first state of charge is positively correlated with the estimated battery pack replacement quantity.

10. The charging cabinet according to claim 8, wherein the power conversion circuit is further configured to charge the battery pack whose state of charge is less than the second state of charge among the plurality of battery packs to the second state of charge at a gradually decreasing charging rate, and is configured to charge the battery pack whose state of charge is the second state of charge among the plurality of battery packs to the first state of charge at a gradually decreasing charging rate.

11. The charging cabinet according to claim 8, wherein the power conversion circuit is configured to charge the battery pack whose state of charge is less than the second state of charge among the plurality of battery packs to the second state of charge at a gradually increasing charging rate, and is configured to charge the battery pack whose state of charge is the second state of charge among the plurality of battery packs to the first state of charge at a gradually increasing charging rate.

12. The charging cabinet according to claim 8, wherein the charging cabinet further comprises a first controller; and
the first controller is configured to: obtain detection information sent by a second controller of each of the plurality of battery packs, and control the power conversion circuit based on the detection information, wherein the detection information indicates a state of charge of a corresponding battery pack.

13. The charging cabinet according to claim 12, wherein the first controller is further configured to determine a quantity of to-be-charged battery packs based on the state of charge of each of the plurality of battery packs and the quantity of battery packs in each of the at least two states of charge; and
the charging rate at which the power conversion circuit charges the battery pack whose state of charge is less than the second state of charge among the plurality of battery packs to the second state of charge is positively correlated with the quantity of to-be-charged battery packs, and the charging rate at which the power conversion circuit charges the battery pack whose state of charge is the second state of charge among the plurality of battery packs to the first state of charge is positively correlated with the quantity of to-be-charged battery packs.

14. The charging cabinet according to claim 1, wherein the at least two states of charge further comprise a third state of charge, and the third state of charge is greater than the second state of charge and is less than the first state of charge.

15. The charging cabinet according to claim 12, wherein the power conversion circuit comprises an alternating current/direct current conversion circuit and a plurality of direct current/direct current conversion circuits,
wherein an input end of the alternating current/direct current conversion circuit is the input end of the power conversion circuit, an output end of the alternating current/direct current conversion circuit is connected to input ends of the plurality of direct current/direct current conversion circuits, and an output end of each of the plurality of direct current/direct current conversion circuits is configured to connect to one of the plurality of output interfaces,
wherein each of the plurality of direct current/direct current conversion circuits is configured to: perform direct current conversion on a direct current, and through the one of the plurality of output interfaces correspondingly connected to the direct current/direct current conversion circuit, output a direct current obtained through the direct current conversion, and
wherein the first controller is configured to control the alternating current/direct current conversion circuit and the plurality of direct current/direct current conversion circuits based on the detection information, to adjust the charging rates at which the plurality of battery packs are charged.

16. The charging cabinet according to claim 12, wherein each of the plurality of battery packs comprises a direct current/direct current conversion circuit and a second controller, and the power conversion circuit is an alternating current/direct current conversion circuit,
wherein an output end of the alternating current/direct current conversion circuit is configured to connect to an input end of the direct current/direct current conversion circuit of each battery pack, and
wherein the first controller is configured to: control the alternating current/direct current conversion circuit based on the detection information, and separately send a control signal to the second controller of each of the plurality of battery packs, so that the second controller of each of the plurality of battery packs controls a corresponding direct current/direct current conversion circuit based on the control signal.

17. A battery pack, wherein the battery pack is charged by using a charging cabinet and the charging cabinet comprises a power conversion circuit, an input interface, and a plurality of output interfaces,
wherein the battery pack is one of a plurality of battery packs connected to the charging cabinet,
wherein the input interface is configured to connect to an alternating current power grid, and each of the plurality of output interfaces is configured to connect to one of the plurality of battery packs,
wherein the plurality of output interfaces are configured to connect to an output end of the power conversion circuit,
wherein an input end of the power conversion circuit is configured to connect to the input interface,
wherein the power conversion circuit is configured to, in a first time period, convert an alternating current supplied by the alternating current power grid into a direct current, and then charge the plurality of battery packs by using the direct current, so that a state of charge of each of the plurality of battery packs is any one of the following at least two states of charge: a first state of charge or a second state of charge, and a quantity of battery packs in each of the at least two states of charge is kept unchanged in the first time period, wherein the first state of charge is 1, the second state of charge is less than the first state of charge, and there is at least one battery pack of the plurality of battery packs in each of the at least two states of charge,
wherein the battery pack comprises a direct current/direct current conversion circuit, a battery cell, and a second controller,
wherein an input end of the direct current/direct current conversion circuit is configured to connect to one of the plurality of output interfaces of the charging cabinet,
wherein the direct current/direct current conversion circuit is configured to perform direct current conversion on an obtained direct current, and then charge the battery cell by using a direct current obtained through the direct current conversion, and
wherein the second controller is configured to send detection information indicating a state of charge of the battery pack to the charging cabinet.

18. The battery pack according to claim 17, wherein the second controller is further configured to control the direct current/direct current conversion circuit based on an obtained control signal, to adjust a charging rate at which the battery cell is charged, wherein the control signal is sent by a first controller of the charging cabinet.

19. A battery pack charging system comprising a charging cabinet and a plurality of battery packs, the charging cabinet comprising a power conversion circuit, an input interface, and a plurality of output interfaces,
wherein the input interface is configured to connect to an alternating current power grid, and each of the plurality of output interfaces is configured to connect to one of the plurality of battery packs,
wherein the plurality of output interfaces are configured to connect to an output end of the power conversion circuit,
wherein an input end of the power conversion circuit is configured to connect to the input interface, and
wherein the power conversion circuit is configured to: in a first time period, convert an alternating current supplied by the alternating current power grid into a direct current, and then charge the plurality of battery packs by using the direct current, so that a state of charge of each of the plurality of battery packs is any one of the following at least two states of charge: a first state of charge or a second state of charge, and a quantity of battery packs in each of the at least two states of charge is kept unchanged in the first time period, wherein the first state of charge is 1, the second state of charge is less than the first state of charge, and there is at least one battery pack in each of the at least two states of charge.

20. The battery pack charging system according to claim 19, wherein a charging rate at which the power conversion circuit charges a battery pack whose state of charge is less than the second state of charge among the plurality of battery packs to the second state of charge is lower than a charging rate at which the power conversion circuit charges a battery pack whose state of charge is the second state of charge among the plurality of battery packs to the first state of charge.
